(19) United States
(12) Patent Application Publication
(10) Pub. No.: US 2022/0044662 A1
(43) Pub. Date: Feb. 10, 2022

(54) Audio Information Playback Method, Audio Information Playback Device, Audio Information Generation Method and Audio Information Generation Device

(71) Applicant: Yamaha Corporation, Hamamatsu-shi (JP)

(72) Inventor: Makoto TACHIBANA, Hamamatsu-shi (JP)

(21) Appl. No.: 17/451,850

(22) Filed: Oct. 22, 2021

Related U.S. Application Data
(63) Continuation of application No. PCT/JP2020/012326, filed on Mar. 19, 2020.

(30) Foreign Application Priority Data
Apr. 26, 2019 (JP) 2019-085558

(51) Int. Cl. G10H 1/00; G10H 1/08

(52) U.S. Cl. CPC G10H 1/0025; G10H 2250/615; G10H 2250/455; G10H 1/08

(57) ABSTRACT

An audio information playback method includes reading audio information, reading separator information, acquiring note-on information and note-off information, moving a playback position, and starting playback. The starting of the playback is from the loop end position to the playback end position of an utterance unit subject to playback in response to acquisition of the note-off information corresponding to the note-on information.

### BACKGROUND

The present disclosure relates to an audio information playback method, an audio information playback device, an audio information generation method and an audio information generation device.

Conventionally, a technique for playing data (a singing synthesizing score) in which each of a plurality of syllables for singing is associated with a note has been known. A device described in the below-mentioned JP 4735544 B2 can change a pitch or a sound generation period of singing voice in real time by synthesizing a singing synthesizing score in accordance with a user's performance operation. Further, it is possible to generate audio information in which respective waveform data pieces of a plurality of syllables are chronologically sequenced by synthesizing the singing synthesizing score and converting data obtained by synthesis of a singing voice into wave data.

### SUMMARY

However, when a singing synthesizing score is synthesized and converted into audio information once, timing for sound generation of each syllable and a length of sound generation of each syllable of the audio information are determined. Therefore, it is difficult to change sound generation or sound deadening according to a user's intention in a natural sounding manner in playback of audio information. That is, although the audio information is normally played in a chronological order, it is not suited for playback control as desired and in real time in accordance with a performance operation or the like. As such, there was a room for improvement in regard to realization of playback control of audio information as desired and in real time.

An object of the present disclosure is to provide an audio information playback method, an audio information playback device, an audio information generation method, an audio information generation device that can realize playback control of audio information as desired and in real time.

According to one aspect of the present disclosure, an audio information playback method includes reading audio information in which waveform data pieces, of each of a plurality of utterance units with defined pitch and order in regard to sound generation, are chronologically sequenced, reading separator information that is associated with the audio information and defines a playback start position, a loop start position, a loop end position and a playback end position in regard to each utterance unit, acquiring note-on information and note-off information, moving a playback position in the audio information based on the separator information in response to acquisition of the note-on information or the note-off information, and starting playback from the loop end position to the playback end position of an utterance unit subject to playback in response to acquisition of the note-off information corresponding to the note-on information, is provided.

According to another aspect of the present disclosure, an audio information generation method includes audio information which is to be played in response to acquisition of note-on information or note-off information and in which waveform data pieces, of each of a plurality of utterance units with defined pitch and order in regard to sound generation, are chronologically sequenced, acquiring a singing synthesizing score in which information pieces designating a pitch of a singing voice to be synthesized are chronologically sequenced in accordance with progression of a musical piece, and generating the audio information by synthesizing the singing synthesizing score and associating separator information defining each of a playback start position at which playback starts in accordance with note-on information, a loop start position, a loop end position and a playback end position at which playback ends in response to acquisition of note-off information in regard to each utterance unit in the singing synthesizing score, is provided.

Other features, elements, characteristics, and advantages of the present disclosure will become more apparent from the following description of preferred embodiments of the present disclosure with reference to the attached drawings, in which:

### BRIEF DESCRIPTION OF THE DRAWING

FIG. 1 is a block diagram of an audio information playback device;

FIG. 2 is a conceptual diagram showing the relationship between a singing synthesizing score and playback data;

FIG. 3 is a functional block diagram of the audio information playback device;

FIG. 4 is a conceptual diagram showing part of waveform sample data in audio information and separator information;

FIG. 5 is a diagram showing separator information with respect to one phrase in a singing synthesizing score;

FIG. 6 is a diagram showing separator information with respect to one phrase in a singing synthesizing score;

FIG. 7 is a flowchart of a real-time playback process; and

FIG. 8 is a diagram showing a modified example of separator information with respect to one phrase in a singing synthesizing score.

### DETAILED DESCRIPTION

Embodiments of the present disclosure will be described below with reference to the drawings.

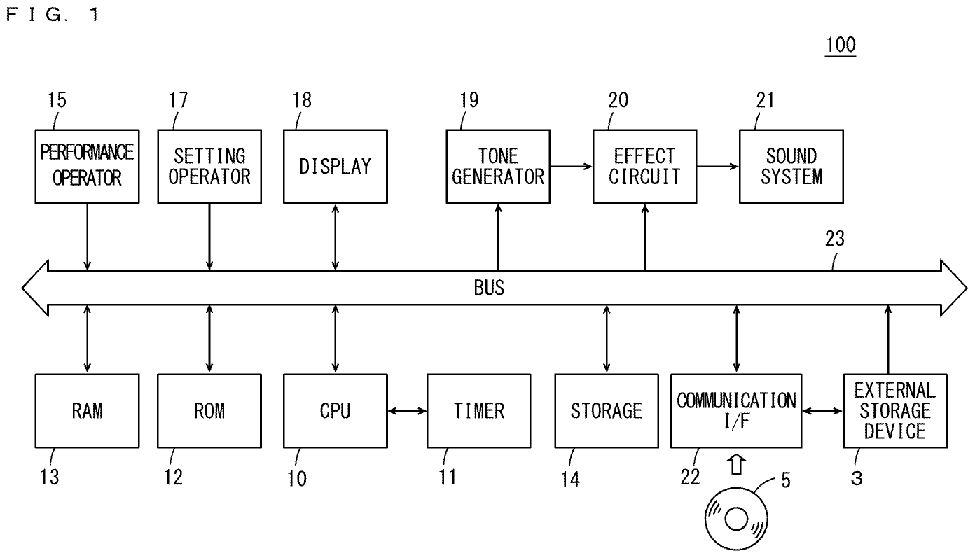

FIG. 1 is a block diagram of an audio information playback device to which an audio information playback method according to one embodiment of the present disclosure is applied. The audio information playback device 100 has a function of playing audio information. The audio information playback device 100 may also serve as a device having a function of generating audio information. Therefore, the name of a device to which the present disclosure is applied is not limited. For example, in a case where the present disclosure is applied to a device having a function of mainly playing audio information, the present device may be referred to as an audio information playback device to which the audio information playback method is applied. Further, in a case where the present disclosure is applied to a device having a function of mainly generating audio information, the present device may be referred to as an audio information generation device to which an audio information generation method is applied.

The audio information playback device 100 includes a bus 23, a CPU (Central Processing Unit) 10, a timer 11, a ROM (Read Only Memory) 12, a RAM (Random Access Memory) 13 and a storage 14. Further, the audio information playback device 100 includes a performance operator 15, a setting operator 17, a display 18, a tone generator 19, an effect circuit 20, a sound system 21 and a communication I/F (Interface) 22.

The bus 23 transfers data between elements in the audio information playback device 100. The CPU 10 is a central processing unit that controls the audio information playback device 100 as a whole. The timer 11 is a module for measuring time. The ROM 12 is a non-volatile memory for storing a control program, various data, etc. The RAM 13 is a volatile memory that is used as a work area and various buffers by the CPU 10. The display 18 is a display module such as a liquid crystal display panel or an organic electro-luminescence panel. The display 18 displays a running state of the audio information playback device 100, various setting screens, messages to a user and so on.

The performance operator 15 is a module for receiving a performance operation of mainly designating a pitch and timing. In the present embodiment, audio information (audio data) can be played in accordance with an operation of the performance operator 15. The audio information playback device 100 is configured to be a keyboard musical instrumental type, for example, and includes a plurality of keys (not shown) in a keyboard. However, the form of the audio information playback device 100 is not limited. As long as being an operator for designating a pitch and timing, the performance operator 15 may be in another form and be a string, for example. Further, the performance operator 15 is not limited to a physical operator, and may be a virtual performance operator to be displayed on a screen by software.

The setting operator 17 is an operation module for performing various settings. The external storage device 3 is connectable to the audio information playback device 100, for example. The storage 14 is a hard disc or a non-volatile memory, for example. The communication I/F 22 is a communication module for communicating with external equipment. The communication I/F 22 may include an MIDI (musical instrument digital interface), a USB (Universal Serial Bus), etc. A program for realizing the present disclosure may be stored in the ROM 12 in advance. Alternatively, the program may be acquired through the communication I/F 22 to be stored in the storage 14.

In regard to at least part of the hardware shown in FIG. 1, it is not required to be built in the audio information playback device 100. The hardware may be realized by an external device connected through an interface such as a USB. Further, the setting operator 17 and so on may be a virtual operator that is to be displayed on a screen and operated by a touch operation.

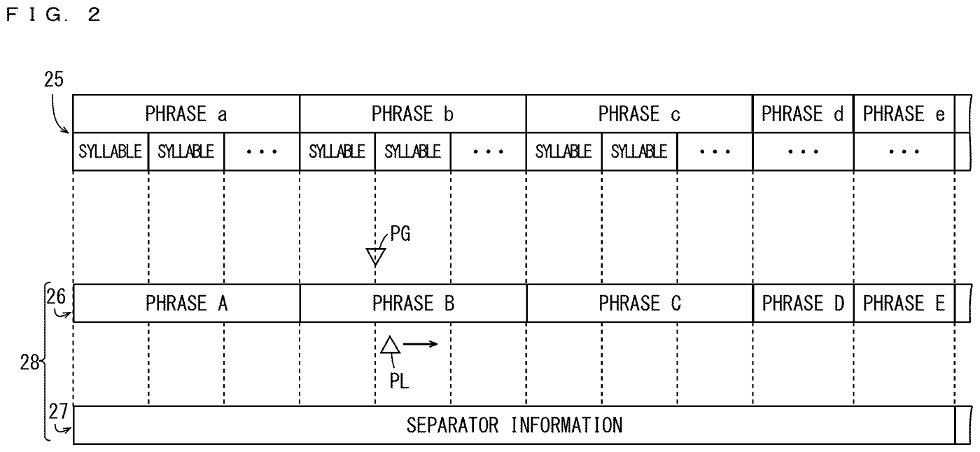

The storage 14 can further store one or more singing synthesizing scores 25 and one or more playback data pieces 28 (see FIG. 2). The singing synthesizing score 25 includes information required for synthesizing a singing voice or lyric text data. Information required for synthesizing a singing voice includes start and end points in time of a note, a pitch of note, a phonetic symbol in a note, an additional parameter for expressing emotions (vibrato, designation of length of consonant, etc.) Lyric text data is data that describes lyrics, and lyrics are divided into syllables for each musical piece. That is, lyric text data has character information in which lyrics are separated into syllables, and the character information also corresponds to the syllables and is to be displayed. Here, a syllable is a unit that is consciously pronounced as a single coherent sound. In the present embodiment, one or a plurality of speeches (groups) corresponding to one note are referred to as a “speech unit.” A “syllable” is one example of a “speech unit.” A “mora” is another example of a “speech unit.” A mora represents a unit of sound having a certain time length. For example, a mora represents a unit of time length equivalent to one Japanese “KANA” letter. As a “speech unit,” either a “syllable” or a “mora” may be used, and a “syllable” and a “mora” may be mixed in a musical piece or a phrase. For example, a “syllable” and a “mora” may be used interchangeably depending on a manner of singing or lyrics.

A phoneme information database is stored in the storage 14 and is referred by the tone generator 19 when a singing voice is synthesized. A phoneme information database is a database for storing speech fragment data. Speech fragment data is data representing a waveform of speech, and includes spectral data of a sample sequence of a speech fragment as waveform data, for example. Further, speech fragment data includes fragment pitch data representing a pitch of waveform of a speech fragment. Lyric text data and speech fragment data may be respectively managed by databases.

The tone generator 19 converts performance data, etc. into a sound signal. In a case where a sound of a singing voice is generated based on the singing synthesizing score 25 which is singing synthesizing sequence data, the tone generator 19 makes reference to a phoneme information database that has been read from the storage 14 and generates singing sound data which is waveform data of a synthesized singing voice. The effect circuit 20 applies a designated acoustic effect to singing sound data generated by the tone generator 19. The sound system 21 converts singing sound data that has been processed by the effect circuit 20 into an analog signal by a digital/analog converter. Then, the sound system 21 amplifies a singing sound that has been converted into the analog signal and outputs the singing sound.

In the present embodiment, in regard to playback of audio information 26, real-time playback for playing a musical piece in accordance with an operation of the performance operator 15 can be performed in addition to normal playback for playing a musical piece sequentially from the beginning of the musical piece. The audio information 26 may be stored in advance in the storage 14 or may be acquired externally afterward. Further, the CPU 10 synthesizes the singing synthesizing score 25 and converts the singing synthesizing score 25 into wave data, thereby also being able to generate the audio information 26.

FIG. 2 is a conceptual diagram showing the relationship between the singing synthesizing score 25 and the playback data 28 before synthesis. The playback data 28 is audio information with separator information, and includes the audio information 26 and the separator information 27 associated with the audio information 26. The singing synthesizing score 25 is data in which information designating a pitch of a singing voice to be synthesized is chronologically sequenced in accordance with progression of a musical piece. The singing synthesizing score 25 includes a plurality of phrases (phrases a to e). A group of syllables (it may be one syllable) that are to be successively generated between rests except for the beginning and end of a musical piece is equivalent to one phrase. Alternatively, a group of moras (it may be one mora) between rests is equivalent to one phrase. Alternatively, a group of syllables and moras between rests is equivalent to one phrase. That is, one phrase is constituted by one or a plurality of “speech units.”

The audio information 26 generated by synthesis of the singing synthesizing score 25 has a plurality of phrases (phrases A to E) corresponding to phrases (phrases a to e) of the singing synthesizing score 25. Therefore, the audio information 26 is waveform sample data in which waveform data of a plurality of syllables (a plurality of waveform samples), each of which has a determined pitch and determined order, are chronologically sequenced.

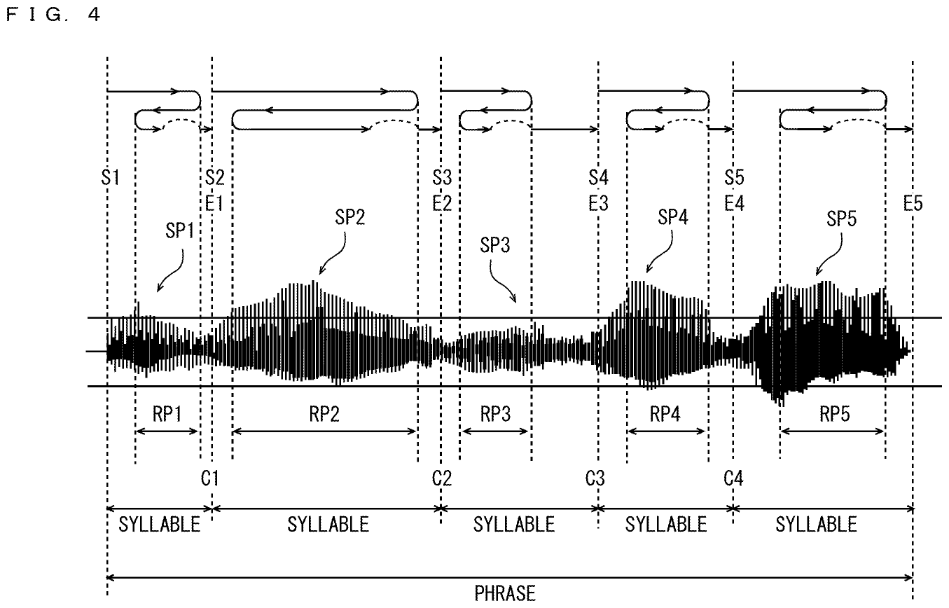

As shown in FIG. 2, a global playback pointer PG and a local playback pointer PL are used for playback of the audio information 26. The global playback pointer PG is global position information that determines which note is to be played at the time of a note-on. The playback pointer PL is position information representing a playback position in a specific note subject to playback according to the global playback pointer PG. In real-time playback, the global playback pointer PG moves in notes in accordance with an operation of the performance operator 15. Further, the CPU 10 moves the playback pointer PL in a note subject to playback based on the separator information 27 associated with the audio information 26. In other words, as shown in FIG. 2, the global playback pointer PG moves to separators between syllables, and the playback pointer PL moves within a syllable. Further, in other words, the global playback pointer PG moves by “speech units,” and the playback pointer PL moves within a “speech unit.” A specific example of a waveform sample in the audio information 26 and the separator information 27 will be described below with reference to FIG. 4.

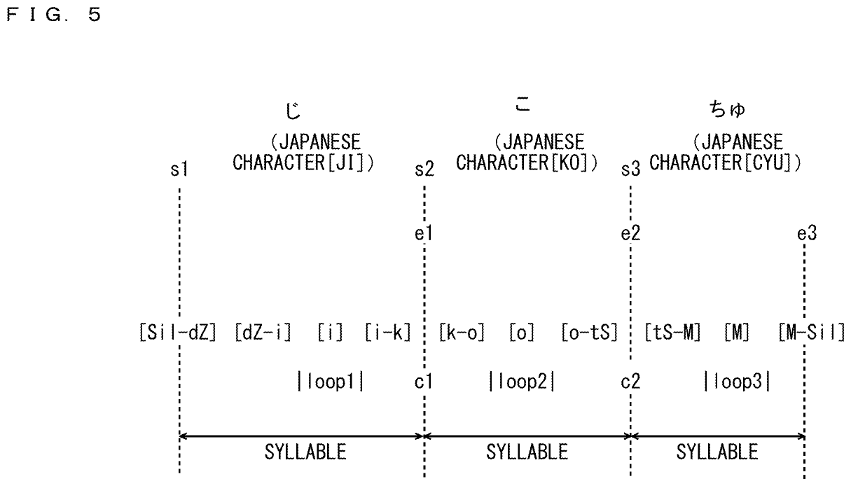

The tone generator 19 outputs additional information in order to create the separator information 27 when converting the singing synthesizing score 25 into the audio information 26. This additional information is be output for each synthesizing frame (256 samples, for example) of the tone generator 19. In the audio information, each syllable is constituted by a plurality of speech fragments. Further, each speech fragment is constituted by a plurality of frames. That is, in the audio information, each “speech unit” is constituted by a plurality of speech fragments. For example, this additional information includes a fragment sample ([Sil-dZ], [i], etc. described below in FIG. 5) used by the frame and a position in a fragment sample of the frame (information representing where in [Sil-dz] the frame is positioned, that is, whether the position of the frame is in Sil or dZ.) The above-mentioned additional information may include a synthesized pitch or phase information in the frame. The CPU 10 specifies the separator information 27 to be played in accordance with each note-on by matching the above-mentioned additional information with the singing synthesizing score 25. In a case where the above-mentioned additional information is not obtained (such as a case where a natural singing voice, etc. is input), the information equivalent to the additional information may be obtained with use of a phoneme recognizer.

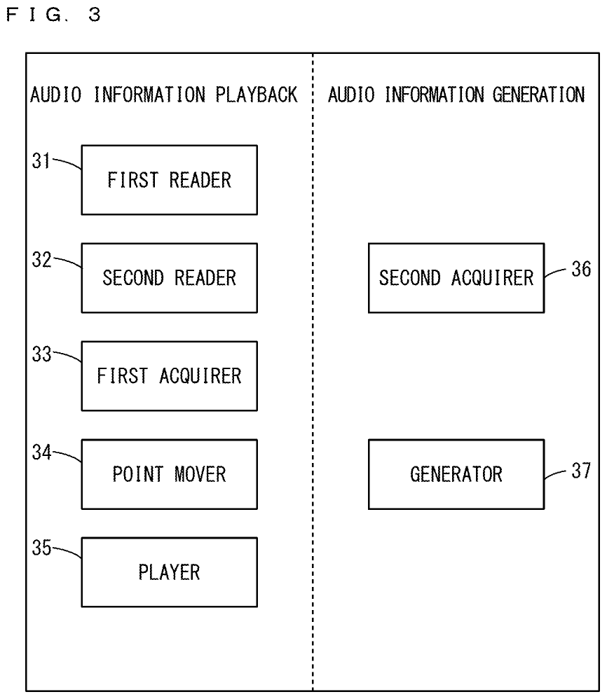

FIG. 3 is a functional block diagram of the audio information playback device 100. The audio information playback device 100 has a first reader 31, a second reader 32, a first acquirer 33, a point mover 34 and a player 35 as the main functional block relating to playback of audio information. The audio information playback device 100 has a second acquirer 36 and a generator 37 as the main functional block relating to generation of audio information.

In regard to the audio information playback function, the functions of the first reader 31 and the second reader 32 are mainly implemented by collaboration of the CPU 10, the RAM 13, the ROM 12 and the storage 14. The function of the first acquirer 33 is mainly implemented by collaboration of the performance operator 15, the CPU 10, the RAM 13, the ROM 12 and the timer 11. The function of the point mover 34 is mainly implemented by collaboration of the CPU 10, the RAM 13, the ROM 12, the timer 11 and the storage 14. The function of the player 35 is mainly implemented by collaboration of the CPU 10, the RAM 13, the ROM 12, the timer 11, the storage 14, the effect circuit 20 and the sound system 21.

The first reader 31 reads the audio information 26 from the storage 14 or the like. The second reader 32 reads the separator information 27 associated with the audio information 26 from the storage 14 or the like. The first acquirer 33 detects an operation of the performance operator 15 and acquires note-on information and note-off information from a detection result. A mechanism for detecting an operation of the performance operator 15 is not limited and may be a mechanism for optically detecting an operation, for example. Note-on information and note-off information may be acquired externally through communication. The point mover 34 moves the global playback pointer PG and/or the playback pointer PL based on the separator information 27 in response to acquisition of note-on information or note-off information.

Detailed behavior in regard to the player 35 will be described with reference to FIG. 4. To provide summary, the player 35 first starts playback from a playback start position (a position indicated by the playback pointer PL at this point in time) of a syllable that is subject to playback and indicated by the global playback pointer PG in response to acquisition of note-on information. Further, in a case where the playback pointer PL arrives at a loop section, the player 35 switches to loop playback of the loop section. Further, in response to acquisition of note-off information corresponding to the note-on information, the player 35 starts playback from a loop end position which is the end of the loop section of a syllable subject to playback to a playback end position. The note-off information corresponding to the note-on information is the information acquired when a release operation with respect to the same key as a depressed key out of the keys included in the performance operator 15 is performed, for example.

On the other hand, in regard to the audio information generation function, the function of the second acquirer 36 is mainly implemented by collaboration of the CPU 10, the RAM 13, the ROM 12 and the storage 14. The function of the generator 37 is mainly implemented by collaboration of the CPU 10, the RAM 13, the ROM 12, the timer 11 and the storage 14. The second acquirer 36 acquires the singing synthesizing score 25 from the storage 14 or the like. The generator 37 generates the audio information 26 by synthesizing the acquired singing synthesizing score 25, and associates the separator information 27 with the generated audio information 26 in regard to each syllable in the singing synthesizing score 25. The generator 37 generates the playback data 28 through this process. The playback data 28 to be used in real time is not limited to data generated by the generator 37.

FIG. 4 is a conceptual diagram showing part of waveform sample data in the audio information 26 and the separator information 27. In FIG. 4, an example of the playback order of the audio information 26 is indicated by arrows. While the unit of the audio information 26 is normally a musical piece, a waveform of a phrase including five syllables is shown in FIG. 4. Waveform sample data pieces corresponding to the five syllables in this phrase are referred to as samples SP1, SP2, SP3, SP4, SP5 in this order. Each sample SP corresponds to each syllable of the singing synthesizing score 25 before synthesis. A playback start position S, a loop section RP, a joint portion C and a playback end position E are defined for each sample SP (for each corresponding syllable) by the separator information 27 associated with the audio information 26. A loop section RP is a section that starts with a loop start position and ends with a loop end position. A playback start position S indicates a position at which playback starts in accordance with note-on information. A loop section RP is a playback section subject to loop playback. A playback end position E indicates a position at which playback ends in response to acquisition of note-off information. Boundaries between adjacent samples SP in a phrase are joint portions C (C1 to C4).

For example, in regard to the sample SP1, a playback start position S1, a loop section RP1 and a playback end position E1 are defined. Similarly, in regard to the samples SP2 to SP5, playback start positions S2 to S5, loop sections RP2 to RP5 and playback end positions E2 to E5 are respectively defined.

The joint portion C1 is a separator position between the samples SP1, SP2 and accords with the playback start position S2 and the playback end position E1. The joint portion C2 is a separator position between the samples SP2, SP3 and accords with the playback start position S3 and the playback end position E2. The joint portion C3 is a separator position between the samples SP3, SP4 and accords with the playback start position S4 and the playback end position E3. The joint portion C4 is a separator position between the samples SP4, SP5 and accords with the playback start position S5 and the playback end position E4.

In the phrase, in regard to samples SP (the samples S2 to S4 in FIG. 4) having adjacent samples SP at both of the front and rear, a playback start position S and a playback end position E are respectively the same as a playback end position E of a front sample SP and a playback start position S of a rear sample SP. The playback start position S of the foremost sample SP (syllable) (SP1 in FIG. 4) in the phrase is the front end position of the sample SP. The playback end position E of the rearmost sample SP (syllable) (SP5 in FIG. 4) in the phrase is the end position of the sample SP. A loop section RP is a section corresponding to a stationary portion (vowel portion) of a syllable in the singing synthesizing score 25.

Based on such separator information 27, playback proceeds as described next in accordance with a user's operation of the performance operator 15. The first acquirer 33 acquires note-on information when detecting a depressing operation of the performance operator 15, and acquires note-off information when detecting a releasing operation of the performance operator 15 being depressed.

For example, suppose that note-on information is acquired when a phrase is not present prior to the sample SP1 or playback of a phrase prior to the sample SP1 has ended. Then, the point mover 34 moves the global playback pointer PG to the playback start position S1, and sets the playback pointer PL at the playback start position S1. Then, the sample SP1 becomes subject to playback, and the player 35 starts playback from the playback start position S1. After the playback from the playback start position S1, the point mover 34 moves the playback pointer PL gradually and rearwardly at a predetermined playback speed. This predetermined playback speed is the same speed as the playback speed in a case where the singing synthesizing score 25 is synthesized, and the audio information 26 is generated. When the playback pointer PL arrives at the loop start position which is the front end of the loop section RP1, the player 35 switches to playback of the loop section RP1.

When the loop section RP1 is played by real-time performance, the player 35 may convert a pitch of the loop section RP1 into a pitch on the basis of the note-on information for playback. In that case, a playback pitch differs depending on which key in the performance operator 15 has been depressed.

For example, the player 35 may perform pitch shifting based on a pitch of the singing synthesizing score 25 corresponding to the sample SP1 and the pitch information of an input note-on such that the pitch corresponds to the note-on. Pitch shifting may be applied to not only the loop section RP1 but also the entire sample SP1.

Eventually, when the playback pointer PL arrives at the loop end position which is the end of the loop section RP, the point mover 34 reverses the moving direction of the playback pointer PL and moves the playback pointer PL toward the loop start position which is the front end of the loop section RP1. Thereafter, when the playback pointer PL arrives at the loop start position, the point mover 34 changes back the moving direction of the playback pointer PL to the rearward direction and moves the playback pointer PL toward the loop end position. Reversing of the moving direction of the playback pointer PL in the loop section RP1 is repeated until the note-off information corresponding to this note-on information is acquired. Therefore, loop playback of the loop section RP is performed. Eventually, when the note-off information is acquired, the point mover 34 causes the playback pointer PL to jump from the playback position at that time to the loop end position which is the end of the loop section RP1. Then, the player 35 starts playback from the loop end position to the playback end position E1. At this time, the player 35 may play smoothly by performing crossfade playback. Even in a case where the note-off information is acquired before the playback pointer PL arrives at the loop section RP1, the point mover 34 causes the playback pointer PL to jump to the loop end position.

When starting playback from the loop end position which is the end of the loop section RP1 and then ending playback at the playback end position E1 which is the next playback end position E, the player 35 ends playback of the sample SP1. Along with that, the player 35 discards the local playback pointer PL. Then, when next note-on information is acquired, the point mover 34 first determines the destination of the global playback pointer PG and moves the global playback pointer PG to the destination as an identification process of a sequence position. In a case where the global playback pointer PG is moved to the playback start position S2, for example, the player 35 then starts playback of the sample SP2 in accordance with a new playback pointer PL that has set the playback start position S2 as a playback start position.

The subsequent behavior of playing the sample SP2 is similar to the behavior of playing the sample P1. Further, the behavior of playing the samples SP3, SP4 is similar to the behavior of playing the sample SP1. In regard to the sample SP5, when playback from the loop end position of the loop section RP5 to the playback end position E5 ends, playback of the phrase shown in FIG. 4 ends. In a case where a phrase subsequent to the phrase shown in FIG. 4 is present, the point mover 34 moves the global playback pointer PG to the front end of the foremost sample SP of the subsequent phrase. In a case where the phrase shown in FIG. 4 is the final phrase in the audio information 26, playback of the audio information 26 ends.

A method of performing loop playback of a loop section RP is not limited. Thus, the method does not have to be a method of going back and forth in the loop section RP but may be a method of repeating playback in the rearward direction from a loop start position to a loop end position. Further, loop playback may be realized with use of a time-stretch technique.

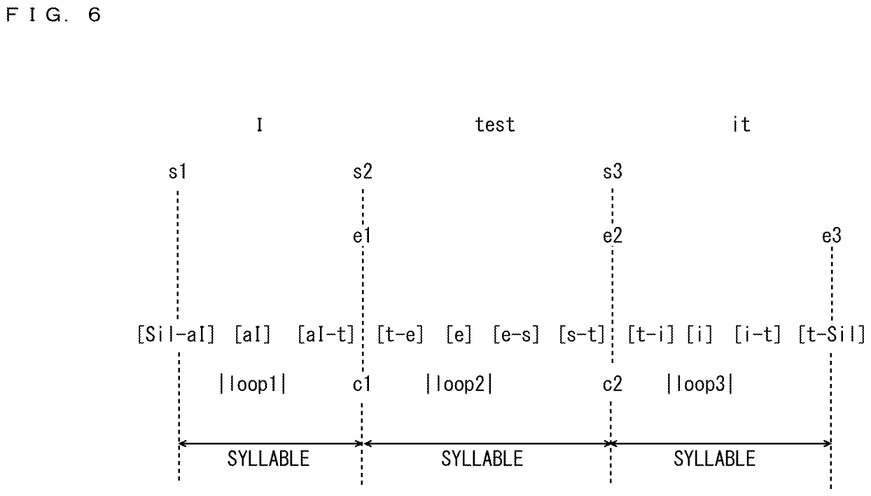

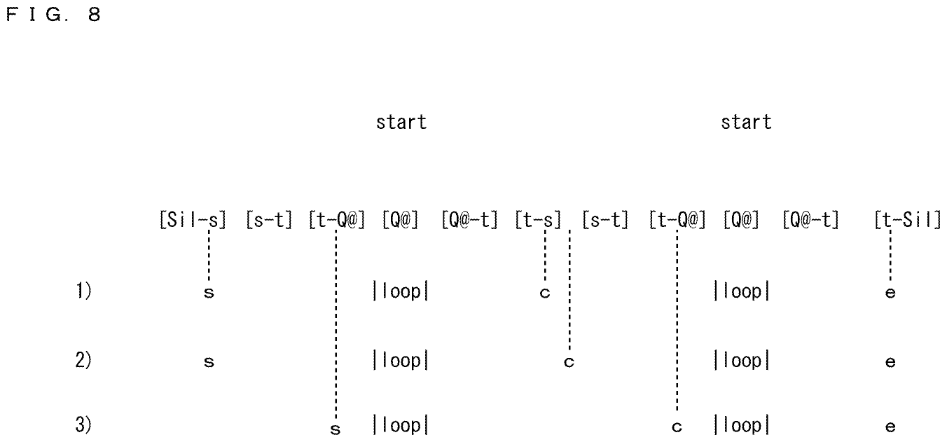

With reference to FIGS. 5 and 6, how the separator information 27 is associated with the audio information 26 when the generator 37 (FIG. 3) generates the playback data 28 from the singing synthesizing score 25 will be described. If it is limited to realization of the audio information playback method of the present disclosure, the separator information 27 may be associated afterward by a normal analysis of audio information. However, in order to associate the separator information 27 with the audio information 26 with higher accuracy, the generator 37 generates the separator information 27 when synthesizing the singing synthesizing score 25 to generate the audio information 26 and makes an association. It is not required that the playback start position S1, the loop section RP1 (the loop start position and the loop end position), the joint portion C and the playback end position E1 correspond to the positions shown in FIG. 4 in the audio information 26. The content of the separator information 27 differs depending on a rule to be applied to generation of the playback data 28. In FIGS. 5 and 6, a representative example of setting of the separator information 27 for enabling natural sounding sounds to be generated will be described. A modified example will be described below with reference to FIG. 8.

FIGS. 5 and 6 are diagrams showing examples of separator information with respect to one phrase in the singing synthesizing score 25. In FIG. 5, the separator information in regard to a phrase constituted by three syllables of “ [symbol] (Japanese character pronounced as [JI]),” “ [symbol] (Japanese character pronounced as [KO])” and “ [symbol] (Japanese character pronounced as [CYU])” is shown, by way of example. In FIG. 6, the separator information in regard to a phrase constituted by three syllables “I,” “test,” and “it” in English is shown, by way of example. Playback start positions s (s1 to s3) and playback end positions e (e1 to e3) in the singing synthesizing score 25 shown in FIGS. 5 and 6 respectively correspond to the playback start positions S and the playback end positions E in the audio information 26 shown in FIG. 4. Further, loop sections ‘loop’ (loop 1 to loop 3) and joint portions (c1, c2) in the singing synthesizing score 25 shown in FIGS. 5 and 6 respectively correspond to the loop sections RP and the joint portions C in the audio information 26 shown in FIG. 4.

In FIGS. 5 and 6, a syllable is represented by a phonetic symbol in a format in conformity to X-SAMPA (Extended Speech Assessment Methods Phonetic Alphabet) as one example. In the speech fragment database that constitutes the singing synthesizing score 25, speech fragment data of a single phoneme such as [a] or [i], or speech fragment data of a phoneme chain such as [a-i] or [a-p] are stored.

In the example of FIG. 5, “ [symbol] (Japanese character pronounced as [JI]),” “ [symbol] (Japanese character pronounced as [KO])” and “ [symbol] (Japanese character pronounced as [CYU])” are phonetic characters. When being represented by phoneme symbols, “ [symbol] (Japanese character [JI])” is represented as [dZ-i]. When being represented by phoneme symbols, “ [symbol] (Japanese character [KO])” is represented as [k-o]. When being represented by phoneme symbols, “ [symbol] (Japanese character [CYU])” is represented as [ts-M]. In the singing synthesizing score 25, representation of a speech fragment of the foremost syllable of a phrase starts with [Sil-], and representation of speech fragment of the last syllable ends with [-Sil]. Further, a speech fragment of a phoneme chain is arranged between phonemes sounds of which are to be generated successively. Therefore, when being represented by phoneme symbols in a case where sounds are to be generated successively as one phrase, “ [symbol] (Japanese character [JI]),” “ [symbol] (Japanese character [KO])” and “ [symbol] (Japanese character [CYU])” are represented as [Sil-dZ], [dZ-i], [i], [i-k], [k-o], [o], [o-ts], [ts-M], [M] and [M-Sil].

In regard to a playback start position s, the playback start position s1 of “ [symbol] (Japanese character [JI])” which is the foremost syllable in the phrase is the front end position of dZ in the speech fragment [Sil-dZ]. Further, a playback start position S of the rear syllable out of two adjacent syllables in the phrase is the rear end position of the speech fragment constituted by the last phoneme of the front syllable and the first phoneme of the rear syllable. For example, in regard to “ [symbol] (Japanese character [KO])” out of the adjacent “ [symbol] (Japanese character [JI])” and “ [symbol] (Japanese character [KO]),” the rear end position of the speech fragment [i-k] constituted by the last phoneme (i) of “ [symbol] L (Japanese character [JI])” and the first phoneme (k) of “ [symbol] (Japanese character [KO])” is the playback start position s2. In regard to “ [symbol] (Japanese character [CYU])” out of adjacent “ [symbol] (Japanese character [KO])” and “ [symbol] (Japanese character [CYU]),” the rear end position of the speech fragment [o-tS] is the playback start position s3.

In regard to a playback end position e, the playback end position e of the front syllable is the same position as the playback start position s of the rear syllable. For example, the playback end position e1 of “ [symbol] (Japanese character [JI])” out of adjacent “ [symbol] (Japanese character [JI])” and “ [symbol] (Japanese character [KO])” is the same position as the playback start position s2 of “ [symbol] (Japanese character [KO]).” The playback end position e2 of “ [symbol] (Japanese character [KO])” out of “ [symbol] (Japanese character [KO])” and “ [symbol] (Japanese character [CYU])” is the same position as the playback start position s3 of “ [symbol] [symbol] (Japanese character [CYU]).” Further, the playback end position e3 of “ [symbol] (Japanese character [CYU])” which is the last syllable in the phrase is the rear end position of M in the speech fragment [M-Sil].

The speech fragments [i], [o], [M] are stationary portions of respective syllables. The sections of these stationary portions are loops 1, 2, 3. Further, the joint portions c1, c2 are respectively at the same positions as the playback end positions e1, e2. In this manner, in a Japanese phrase, a joint portion c is positioned between consonants.

The generator 37 generates the separator information 27 when synthesizing the singing synthesizing score 25 to generate the audio information 26. At this time, the generator 37 generates the separator information 27 in which a playback start position s, a loop section ‘loop’ (a loop start position and a loop end position), a joint portion c and a playback end position e respectively correspond to a playback start position S, a loop section RP (a loop start position and a loop end position), a joint portion C and a playback end position E. Then, the generator 37 generates the playback data 28 by associating the generated separator information 27 with the audio information 26. Therefore, in the audio information 26, the playback start position s of the foremost syllable out of a plurality of adjacent syllables in each phrase is the front end position of the foremost syllable. Further, in the audio information 26, the playback end position e of the rearmost syllable out of a plurality of adjacent syllables in each phrase is the end position of the rearmost syllable.

When the singing synthesizing score 25 is synthesized, the length of a section of a stationary portion (loop section ‘loop’) in each syllable in the singing synthesizing score 25 may be smaller than a predetermined period of time. In that case, loop playback might not be properly performed because the loop section RP is too short. As such, the generator 37 may set a section of a stationary portion as a loop section RP in the separator information 27 in a case where the length of the section of the stationary portion is equal to or larger than the above-mentioned predetermined period of time.

Next, in the example of FIG. 6, when being represented by phoneme symbols, [l], [test] and [it] are represented as [Sil-a], [al], [al-t], [t-e], [e], [e-s], [s-t], [t-i], [i], [i-t] and [t-Sil].

In regard to a playback start position s, the playback start position s1 of [l] which is the foremost syllable in the phrase is the front end position of al in the speech fragment [Sil-al]. The playback start position s2 of [test] is the rear end position of the speech fragment [al-t]. The playback start position s3 of [it] is the rear end position of the speech fragment [s-t].

In regard to a playback end position e, the playback end position e1 of [l] is the same position as the playback start position s2 of [test]. The playback end position e2 of [test] is the same position as the playback start position s3 of [it]. Further, the playback end position e3 of [it] which is the last syllable in the phrase is the rear end position of t in the speech fragment [t-Sil].

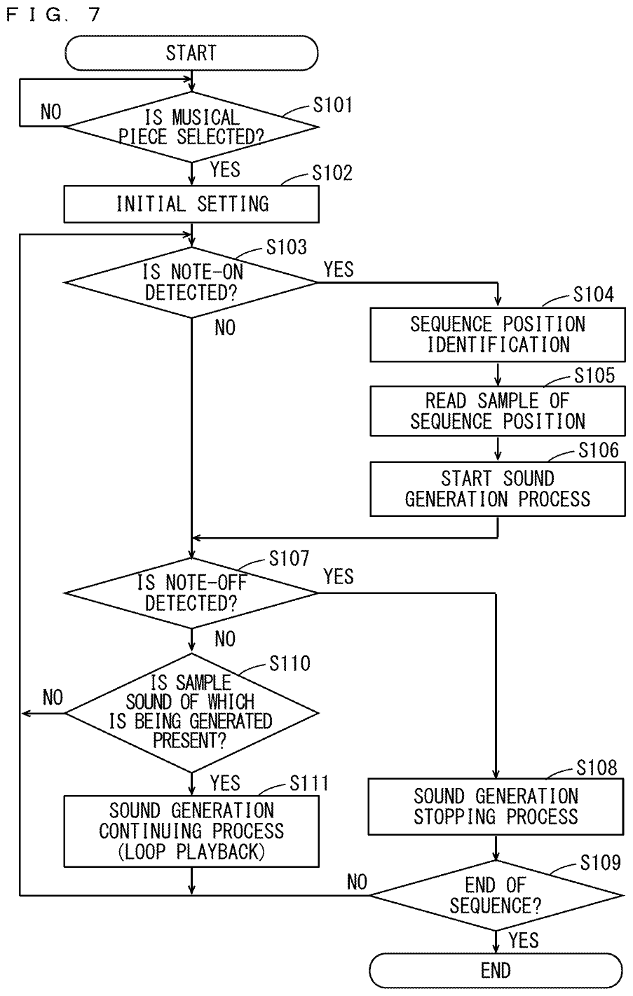

FIG. 7 is a flowchart of a real-time playback process. This process is realized when the CPU 10 deploys a program stored in the ROM 12 into the RAM 13 and executes the program, for example.

When power is turned on, the CPU 10 waits until an operation of selecting a musical piece to be played is received from a user (step S101). In a case where an operation of selecting a musical piece is not performed even after a certain period of time elapses, the CPU 10 may determine that a default musical piece has been selected. When receiving selection of a musical piece, the CPU 10 performs an initial setting (step S102). In this initial setting, the CPU 10 reads playback data 28 of the selected musical piece (audio information 26 and separator information 27) and sets a sequence position at an initial position. That is, the CPU 10 positions a global playback pointer PG and a playback pointer PL at the front end of the foremost syllable of the foremost phrase in the audio information 26.

Next, the CPU 10 determines whether a note-on based on an operation of the performance operator 15 is detected (whether note-on information is acquired) (step S103). Then, in a case where a note-on is not detected, the CPU 10 determines whether a note-off is detected (whether note-off information is acquired) (step S107). On the other hand, in a case where a note-on is detected, the CPU 10 executes an identification process in regard to a sequence position (step S104).

In this identification process, the positions of the global playback pointer PG and the local playback pointer PL are determined. For example, in a case where the difference between a point in time at which a previous note-on is detected and a point in time at which a current note-on is detected is equal to or larger than a predetermined period of time, the global playback pointer PG advances by one. An accompaniment of a selected musical piece may be played in parallel with the real-time playback process. In that case, the global playback pointer PG may be moved in accordance with a playback position of the accompaniment. Alternatively, accompaniment may be played in accordance with movement of the global playback pointer PG.

As shown in the example of FIG. 4, in a case where the global playback pointer PG and the playback pointer PL are positioned at the playback start position S1 of the sample SP1, the CPU 10 starts a process of advancing the playback pointer PL in the sample SP1. In a case where the playback pointer PL is positioned in the loop section RP1 (during loop playback), the CPU 10 advances the playback pointer PL such that the playback pointer PL moves back and forth in the loop section RP1.

In the above-mentioned identification process, in a case where a plurality of note-ons are detected due to depression of a plurality of keys in a certain period of time, the CPU 10 may generate a sound of the sample SP1 in a plurality of scales similarly to generation of a chord without advancing the position of the global playback pointer PG. Alternatively, the CPU 10 may advance the position of the global playback pointer PG, and sounds of the sample SP1 and the sample SP2 may be generated at the same time in respective scales. In a case where two keys are depressed while keeping a predetermined time interval, “YES” is selected as determination made in the step S103, “YES” is selected as determination made in the step S107, and then “YES” is selected as determination made in the step S103 again.

Even in a case where a plurality of keys are operated at the same time, the CPU 10 may output only a single sound. In this case, the CPU 10 may execute a process in accordance with the highest pitch or may execute a process in accordance with the lowest pitch, out of the pitches of keys that are depressed at the same time. In a case where a plurality of keys are depressed in a certain period of time, the CPU 10 may execute a process in accordance with a pitch of a key that is depressed last.

Next, in the step S105, the CPU 10 reads a sample of a sequence position in the audio information 26. In the step S106, the CPU 10 starts a sound generation process of generating a sound of the sample that is read in the step S105. The CPU 10 shifts a pitch of a sound to be generated in accordance with the difference between a pitch defined in the audio information 26 and a pitch based on this note-on information. With this process, a pitch of a sample subject to playback is converted into a pitch based on the note-on information for playback. Further, in case of sound generation of a chord, a sound is generated at a plurality of pitches based on respective note-on information pieces. After the step S106, the CPU 10 causes the process to proceed to the step S107.

In a case where a note-off is not detected in the step S107, a key continues to be depressed. Thus, the CPU 10 determines whether a sample a sound of which is being generated is present (step S110). Then, in a case where a sample a sound of which is being generated is not present, the CPU 10 causes the process to return to the step S103. On the other hand, in a case where a sample a sound of which is being generated is present, the CPU 10 executes a sound generation continuing process (step S111) and causes the process to return to the step S103. As for the example shown in FIG. 4, in a case where a sound of the sample SP1 is being generated, playback of a portion positioned farther rearwardly of the position indicated by the playback pointer PL continues to be played, for example. In particular, in a case where the playback pointer PL is positioned in the loop section RP1, loop playback of the loop section RP1 continues.

In a case where a note-off is detected in the step S107, it can be normally determined that a releasing operation of a depressed key is performed. Thus, the CPU 10 executes a sound generation stopping process in the step S108. Here, the CPU 10 causes the playback pointer PL to jump to the loop end position which is the end of the loop section RP in the sample SP a sound of which is being generated, and starts playback from the position subsequent to the position to which the playback pointer PL has jumped to the adjacent rearward playback end position E. As for the example shown in FIG. 4, in a case where note-off information is acquired during generation of sound of the sample SP1, for example, the CPU 10 causes the playback pointer PL to jump to the loop end position of the loop section RP1. Along with that, the CPU 10 starts playback from the loop end position of the loop section RP1 to the adjacent rearward playback end position E1. For example, in the example of FIG. 6, in a case where the sound of “test” is stretched to be played, “e” which is a vowel is stretched. Thereafter, “st” is played to the playback end position E1 in accordance with a note-off, so that a sound of “st” which is a consonant is generated firmly. “test” can be stretched to be played in a natural sounding manner.

Next, in the step S109, the CPU 10 determines whether the playback position has arrived at the sequence end, that is, whether the CPU 10 has played till the end of the audio information 26 of a selected musical piece. Then, in a case where not having played till the end of the audio information of the selected musical piece, the CPU 10 causes the process to return to the step S103. In a case where having played till the end of the audio information 26 of the selected musical piece, the CPU 10 ends the real-time playback process shown in FIG. 7.

With the present embodiment, playback control of audio information can be realized as desired and in real time. In particular, in response to acquisition of note-on information, the CPU 10 starts playback from a playback start position S. Further, the CPU 10 switches to loop playback in a case where the playback position arrives at a loop section RP. Further, in response to acquisition of note-off information corresponding to note-on information, the CPU 10 starts playback from a loop end position which is the end of a loop section RP of a syllable subject to playback to a playback end position e. A user can cause a sound of a syllable to be generated at a desired time by operating the performance operator 15. Also, the user can stretch a sound of a desired syllable as desired by loop playback of a loop section RP by continuing to depress the performance operator 15. Further, with pitch-shifting, the user can play a musical piece while changing a pitch of a sound to be generated in a syllable in accordance with the performance operator 15 operated by the user. Therefore, playback of the audio information can be controlled as desired and in real time.

Further, the CPU 10 generates the audio information 26 by synthesizing the singing synthesizing score 25, and associates the separator information 27 with the audio information 26 in regard to each syllable in the singing synthesizing score 25. Therefore, the CPU 10 can generate the audio information that can be controlled to be played as desired and in real time. Further, accuracy of association of the audio information 26 with the separator information 27 can be enhanced.

Further, a loop section RP is a section corresponding to a stationary portion in each syllable in the singing synthesizing score 25. Further, in a case where the length of a section of a stationary portion in each syllable in the singing synthesizing score 25 is smaller than a predetermined period of time, the CPU 10 makes the length of the section be equal to or larger than the predetermined period of time, and associates the section of the stationary portion with the audio information 26 as a loop section RP. Therefore, a sound to be generated during loop playback can sound naturally.

Next, a modified example of a setting of the separator information 27 will be described with reference to FIG. 8. FIG. 8 is a diagram showing a modified example of separator information with respect to one phrase in the singing synthesizing score 25. In the example of FIG. 8, the separator information with respect to a phrase made of two English syllables “start” and “start.” The three patterns (1), (2) and (3) in FIG. 8 have the following characteristics.

First, in the pattern (1), all consonants are included in a part subsequent to note-on. Therefore, when a sound of each note is generated slowly and individually, each generated sound (the [Sa] column of the Japanese syllabary table, etc.) is clear. On the other hand, in a case where a sound is generated together with accompaniment in a timely sound generating manner, it is necessary to play far ahead of time depending on a type of consonant.

In the pattern (2), a joint portion is located between consonants that is unlikely to be perceived as having a fragment connection. In this modified example, a position that is located forwardly of a note-on by a certain length may be a separator position regardless of a type of consonant. In this case, because the phrase may be played ahead of time by a certain period of time regardless of lyrics, the phrase can be played relatively easily together with an accompaniment in a timely sound generating manner.

In the pattern (3), the phrase can be played at the same position as the position of a note-on in the original singing synthesizing score. However, in a case where a sound of phrase is generated individually, even when a note of “ [symbol] (Japanese character [Sa])” in the lyrics is played, only the sound of [a] is generated.

Out of the three patterns (1), (2) and (3), the pattern (2) is the same as the pattern to which the rule described in FIG. 6 is applied. When being represented by the phoneme symbols, “start” and “start” are represented as [Sil-s] [s-t] [t-Q@] [Q@] [Q@-t] [t-s] [s-t] [t-Q@] [Q@] [Q@-t] and [t-Sil].

In any of the patterns (1), (2) and (3), the playback end position e of the rear “start” is the rear end position of t in the speech fragment [t-Sil]. Further, in any of the patterns (1), (2) and (3), the speech fragment [Q@] is a stationary portion of each syllable, and these sections are loop sections ‘loop.’

In the pattern (1), in regard to a playback start position s, the playback start position s of the front “start” in the phrase is the front end position of s in the speech fragment [Sil-s]. Further, the playback start position s of the rear syllable out of the two adjacent syllables in the phrase is the same as a joint portion c. That is, the joint portion c is located at the front end position of the rear phoneme in the speech fragment constituted by the last phoneme of the front syllable and the first phoneme of the rear syllable. For example, the front end position of s in [t-s] is the joint portion c. The playback end position e of the front syllable is the same as the playback start position s of the rear syllable and the joint portion c.

In the pattern (3), the playback start position s is the front end position of a rear phoneme (a phoneme corresponding to a stationary portion) in the speech segment constituted by a phoneme that is stretched as a loop section “loop” (the phoneme corresponding to the stationary portion) and a phoneme that is one phoneme prior to the phoneme. For example, the front end position of Q@ in the first [t-Q@] is the playback start position s. Further, the playback start position s of the rear syllable is the same as a joint portion c. The joint portion c is the front end position of Q@ in the second [t-Q@]. The playback end position e of the front syllable is the same as the playback start position s of the rear syllable and the joint portion c.

In this manner, when the playback data 28 is to be generated, a rule to be applied is not limited to one type. Further, a rule to be applied may differ depending on the language.

In a case where the length of a section of a stationary portion (a loop section ‘loop’) is smaller than a predetermined period of time, suppose that a process of extending the length of the section of the stationary portion is not employed, and the sufficient length of the loop section RP cannot be ensured in the audio information 26. In this case, in the step S111, loop playback may be performed with use of a section of [i] of the speech fragment [dZ-i], for example.

Even in a case where the singing synthesizing score 25 has a parameter for expressing emotions such as vibrato, the information may be ignored, and the singing synthesizing score 25 may be converted into the audio information 26. Meanwhile, the playback data 28 may include a parameter for expressing emotions such as vibrato as information. Even in this case, in the real-time playback process of the audio information 26 in the playback data 28, reproduction of a parameter for expressing emotions such as vibrato may be disabled. Alternatively, in a case where vibrato is to be reproduced, a point in time at which a sound is generated may be changed while a period of vibrate included in the audio information 26 is maintained by matching of repeat timing in loop playback with an amplitude waveform of vibrato.

In the step S106, foreman shift may also be used. Further, adaptation of pitch shifting is not required.

Predetermined sample data may be kept. When note-off information is acquired, the above-mentioned predetermined sample data may be played as an aftertouch process instead of playback from the loop end position which is the end of the loop section RP to the playback end position e in the step S108. Alternatively, a grouping process as described in “WO 2016/152715 A1” may be applied as an aftertouch process. For example, syllables “ [symbol] (Japanese character [KO])” and “ [symbol] (Japanese character [l])” are grouped, a sound of “ [symbol] (Japanese character [l])” may be generated subsequently to the end of sound generation of “ [symbol] (Japanese character [KO])” in response to acquisition of note-off information during sound generation of “ [symbol] (Japanese character [KO]).”

The audio information 26 to be used in the real-time playback process is not limited to a sample SP (waveform data corresponding to a syllable) equivalent to a syllable of singing. That is, the audio information playback method of the present disclosure may be applied to audio information not based on singing. Therefore, the audio information 26 is not necessarily limited to be generated by synthesis of singing. In a case where separator information is associated with audio information not based on singing, S (Sustain) in an envelope waveform is associated with a section for loop playback, and R (release) may be associated with end information to be played at the time of note-off.

In the present embodiment, the performance operator 15 has a function of designating a pitch. However, the number of input operators for inputting note-on information and note-off information may be limited to be equal to or larger than one. In this case, although an input operator may be a dedicated operator, the input operator may be assigned to part of the performance operator 15 (two white keys having the lowest pitch in a keyboard, for example). For example, each time information is input by an input operator, the CPU 10 may be configured to seek a next separator position and move a global playback pointer PG and/or a playback pointer PL.

The number of channels that plays the audio information 26 is not limited to one. The present disclosure may be applied to each of a plurality of channels that share the separator information 27. In this case, a channel that plays an accompaniment may be not subject to a shift process in regard to a pitch of sound generation.

Although the present disclosure has been described based on preferred embodiments, the present disclosure is not limited to those, and various embodiments can be included without departing from the scope of the present disclosure.

In regard to application of the present disclosure, in a case where only an audio information playback function is to be focused, the present device is not required to have an audio information generation function. Conversely, in a case where only an audio information generation function is to be focused, the present device is not required to have an audio information playback function.

Similar effects to the effects of the present disclosure may be obtained by reading a control program from a recording medium storing the control program represented by software for realizing the present disclosure. In this case, a program code itself that has been read from the recording medium implements a new function of the present disclosure, and a non-transitory computer-readable recording medium 5 (see FIG. 1) is the present disclosure. For example, as shown in FIG. 1, the CPU 10 can read a program code from the recording medium 5 through the communication I/F 22. Further, a program code may be supplied through a transmission medium, etc. In that case, the program code itself realizes the present disclosure. As a non-transitory computer-readable recording medium 5, a floppy disc, a hard disc, an optical disc, an optical magnetic disc, a CD-ROM, a CD-R, a DVD-ROM, a DVD-R, a magnetic tape, a non-volatile memory card, etc. can be used. Further, as a non-transitory computer readable recording medium, a recording medium that holds a program for a certain period of time such as a volatile memory (DRAM (Dynamic Random Access Memory)) in a computer system that serves as a server or a client in a case where the program is transmitted through a network such as the Internet or a communication line such as a telephone line.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/we claim:

1. An audio information playback method comprising:
reading audio information in which waveform data pieces, of each of a plurality of utterance units with defined pitch and order in regard to sound generation, are chronologically sequenced;
reading separator information that is associated with the audio information and that defines a playback start position, a loop start position, a loop end position, and a playback end position in regard to each utterance unit;
acquiring note-on information and note-off information;
moving a playback position in the audio information based on the separator information in response to acquisition of the note-on information or the note-off information; and
starting playback from the loop end position to the playback end position of an utterance unit subject to playback in response to acquisition of the note-off information corresponding to the note-on information.

2. The audio information playback method according to claim 1, wherein
playback starts from the playback start position of an utterance unit that is indicated by the playback position and subject to playback in response to acquisition of the note-on information, and playback switches to loop playback in a case where the playback position arrives at the loop start position.

3. The audio information playback method according to claim 2, wherein
a pitch of the loop playback is converted into a pitch based on the note-on information for playback when the loop playback is performed.

4. The audio information playback method according to claim 1, wherein
the audio information is obtained by synthesis of a singing synthesizing score in which information pieces designating a pitch of a synthesizable singing voice are chronologically sequenced in accordance with progression of a musical piece.

5. The audio information playback method according to claim 4, wherein
the separator information is associated with the audio information when the singing synthesizing score is synthesized.

6. The audio information playback method according to claim 4, wherein
the playback start position of a rear utterance unit out of two adjacent utterance units of the audio information is equivalent to a rear end position of an utterance fragment constituted by a last phoneme of a front utterance unit and a first phoneme of the rear utterance unit out of two corresponding utterance units in the singing synthetizing score before synthesis.

7. The audio information playback method according to claim 1, wherein
the playback end position of a rearmost utterance unit out of a plurality of utterance units in each phrase of the audio information is an end position of the rearmost utterance unit.

8. An audio information generation method comprising:
generating audio information which is playable in response to acquisition of note-on information or note-off information and in which waveform data pieces, of each of a plurality of utterance units with defined pitch and order in regard to sound generation, are chronologically sequenced;
acquiring a singing synthesizing score in which information pieces designating a pitch of a synthesizable singing voice are chronologically sequenced in accordance with progression of a musical piece; and
generating the audio information by synthesizing the singing synthesizing score and associating separator information defining each of a playback start position at which playback starts in accordance with note-on information, a loop start position, a loop end position, and a playback end position at which playback ends in accordance with note-off information in regard to each utterance unit in the singing synthesizing score.

9. The audio information generation method according to claim 8, wherein
when the singing synthesizing score is synthesized, a section of a stationary portion of each utterance unit in the singing synthesizing score is associated with the audio information as the separator information defining the loop start position and the loop end position.

10. The audio information generation method according to claim 9, wherein
when the singing synthesizing score is synthesized, in a case where a length of a section of the stationary portion is smaller than a predetermined period of time in regard to each utterance unit in the singing synthesizing score, the section of the stationary portion is changed to have a length equal to or larger than the predetermined period of time and is associated with the audio information as the separator information defining the loop start position and the loop end position.

11. The audio information generation method according to claim 8, wherein
when the singing synthesizing score is synthesized, a read end position of an utterance fragment constituted by a last phoneme of a front utterance unit and a first phoneme of a rear utterance unit out of two adjacent utterance units in the singing synthesizing score is associated with the audio information as the separator information defining the playback start position of the rear utterance unit out of two adjacent utterance units of the audio information.

12. An audio information playback device comprising a hardware processor,
the hardware processor:
acquiring audio information in which waveform data pieces, of each of a plurality of utterance units with defined pitch and order in regard to sound generation, are chronologically sequenced, and separator information which is associated with the audio information and defines a playback start position, a loop start position, a loop end position, and a playback end position in regard to each utterance unit, and moving a playback position in the audio information based on the separator information in response to acquisition of note-on information and note-off information; and
starting playback from the playback start position of an utterance unit that is indicated by a moved playback position and subject to playback in response to acquisition of the note-on information, and starting playback from the loop end position of the utterance unit subject to playback to the playback end position in response to acquisition of the note-off information corresponding to the note-on information.

13. The audio information playback device according to claim 12, wherein
the hardware processor starts playback from the playback start position of an utterance unit that is indicated by the playback position and subject to playback in response to acquisition of the note-on information, and switches to loop playback in a case where the playback position arrives at the loop start position.

14. The audio information playback device according to claim 13, wherein
the hardware processor converts a pitch of the loop playback into a pitch based on the note-on information when performing the loop playback.

15. The audio information playback device according to claim 12, wherein
the audio information is obtained by synthesis of a singing synthesizing score in which information pieces designating a pitch of a synthesizable singing voice synthesized are chronologically sequenced in accordance with progression of a musical piece.

16. The audio information playback device according to claim 15, wherein
the separator information is associated with the audio information when the singing synthesizing score is synthesized.

17. An audio information generation device comprising a hardware processor that generates audio information which is played in response to acquisition of note-on information or note-off information and in which waveform data pieces, of each of a plurality of utterance units with defined pitch and order in regard to sound generation, are chronologically sequenced, wherein
the hardware processor is configured to:
acquire a singing synthesizing score in which information pieces designating a pitch of a synthesizable singing voice are chronologically sequenced in accordance with progression of a musical piece; and
generate the audio information by synthesizing an acquired singing synthesizing score, and associating separator information defining each of a playback start position at which playback starts in accordance with note-on information, a loop start position, a loop end position, and a playback end position at which playback ends in accordance with note-off information with the audio information.

18. The audio information generation device according to claim 17, wherein
the hardware processor, when synthesizing the singing synthesizing score, associates a section of a stationary portion of each utterance unit in the singing synthesizing score with the audio information as the separator information defining the loop start position and the loop end position.

19. The audio information generation device according to claim 18, wherein
the hardware processor, when synthesizing the singing synthesizing score, in a case where a length of a section of the stationary portion is smaller than a predetermined period of time, makes the section of the stationary portion have a length equal to or larger than the predetermined period of time and associates the section with the audio information as the separator information defining the loop start position and the loop end position.

20. The audio information generation device according to claim 17, wherein
the hardware processor, when synthesizing the singing synthesizing score, associates a rear end position of an utterance fragment constituted by a last phoneme of a front utterance unit and a first phoneme of a rear utterance unit out of two adjacent utterance units in the singing synthesizing score with the audio information as the separator information defining the playback start position of the rear utterance unit out of two adjacent utterance units of the audio information.
